(19) United States
(12) Patent Application Publication
(10) Pub. No.: US 2013/0340514 A1
(43) Pub. Date: Dec. 26, 2013

(54) Pressure Sensor Apparatus

(71) Applicant: Hitachi Automotive Systems, Ltd., Hitachinaka-shi (JP)

(72) Inventors: Miho Tobita, Hitachinaka (JP); Hiroshi Onuki, Hitachi (JP); Jun Kubo, Hitachinaka (JP); Kenji Nakabayashi, Hitachinaka (JP)

(21) Appl. No.: 13/913,947

(22) Filed: Jun. 10, 2013

(30) Foreign Application Priority Data
Jun. 25, 2012 (JP) 2012-141585

(51) Int. Cl. G01M 15/10

(52) U.S. Cl. CPC G01M 15/106
USPC 73/114.76

(57) ABSTRACT

To implement a downsized pressure sensor apparatus, a pressure sensor apparatus of the present invention includes a housing including a first pressure introduction passage for introducing a first pressure and a second pressure introduction passage for introducing a second pressure, a first pressure detection element provided in the housing and configured to detect the pressure introduced from the first pressure introduction passage, and a second pressure detection element provided in the housing and configured to detect the pressure introduced from the second pressure introduction passage, wherein a circuit substrate is placed above the first and second pressure detection elements, and a first intermediate terminal configured to electrically connect the first pressure detection element with the circuit substrate and a second intermediate terminal configured to electrically connect the second pressure detection element with the circuit substrate are inserted into the housing.

### BACKGROUND OF THE INVENTION

1. Field of the Invention

The present invention relates to a pressure sensor apparatus to be installed in an exhaust system of an internal combustion engine.

2. Description of the Related Art

Particulate matter (hereinafter, referred to as PM) included in the exhaust gas emitted from the body of an internal combustion engine such as a diesel engine has been a problem. Europe, where diesel engine vehicles have become popular, mainly promotes the mandatory installation of a diesel particulate filter (hereinafter, referred to as DPF) for collecting PM. Upon collecting a predetermined amount of PM, the DPF is heated to burn out the collected PM. The amount of the PM collected by the DPF can be estimated according to the difference between the upstream pressure and the downstream pressure in the DPF. This prevents the DPF from being clogged with the PM. Thus, when being equipped with a DPF, a vehicle needs to be equipped with a pressure sensor for detecting the upstream and downstream pressures in the DPF.

A pressure sensor apparatus disclosed in JP-2000-28458-A is an example of sensor apparatuses in the past.

### SUMMARY OF THE INVENTION

Presently, there is a need to further downsize the pressure sensor apparatus fixedly placed in an engine room because of a downsized vehicle and a further complicated engine room with the rise of low environmental load vehicles.

JP-2000-28458-A discloses that a sensor chip for detecting a pressure is adhesively fixed at a sensor chip case and a wiring connects the chip with a signal lead terminal integrally molded in the sensor chip case. JP-2000-28458-A discloses that two pressure sensors for detecting an inlet pressure and the atmospheric pressure are housed in a package to make the apparatus more compact. However, in JP-2000-28458-A, the signal lead terminal integrally molded in the sensor chip case causes the sensor chip case to be large. This also causes the housing for the sensor chip case to be large. In other words, there is room to study for the downsizing of the pressure sensor in JP-2000-28458-A.

An objective of the present invention is to implement a downsized pressure sensor apparatus.

In order to solve the problem, a pressure sensor apparatus according to the present invention includes a housing including a first pressure introduction passage for introducing a first pressure and a second pressure introduction passage for introducing a second pressure, a first pressure detection element provided in the housing and configured to detect the pressure introduced from the first pressure introduction passage, and a second pressure detection element provided in the housing and configured to detect the pressure introduced from the second pressure introduction passage, wherein a circuit substrate is placed above the first and second pressure detection elements, and a first intermediate terminal configured to electrically connect the first pressure detection element with the circuit substrate and a second intermediate terminal configured to electrically connect the second pressure detection element with the circuit substrate are inserted into the housing.

The present invention can downsize a pressure sensor apparatus.

### BRIEF DESCRIPTION OF THE DRAWINGS

FIG. 1 is a view of the structure of a diesel engine describing an embodiment of the present invention;

FIGS. 2A and 2B are schematic views of a pressure sensor apparatus describing a first embodiment of the present invention;

FIG. 3 is a view for illustrating the circuit structure of the present invention; and

FIGS. 4A to 4C are schematic views of a pressure sensor apparatus describing a second embodiment of the present invention.

### DESCRIPTION OF THE PREFERRED EMBODIMENTS

Hereinafter, embodiments of the present invention will be described.

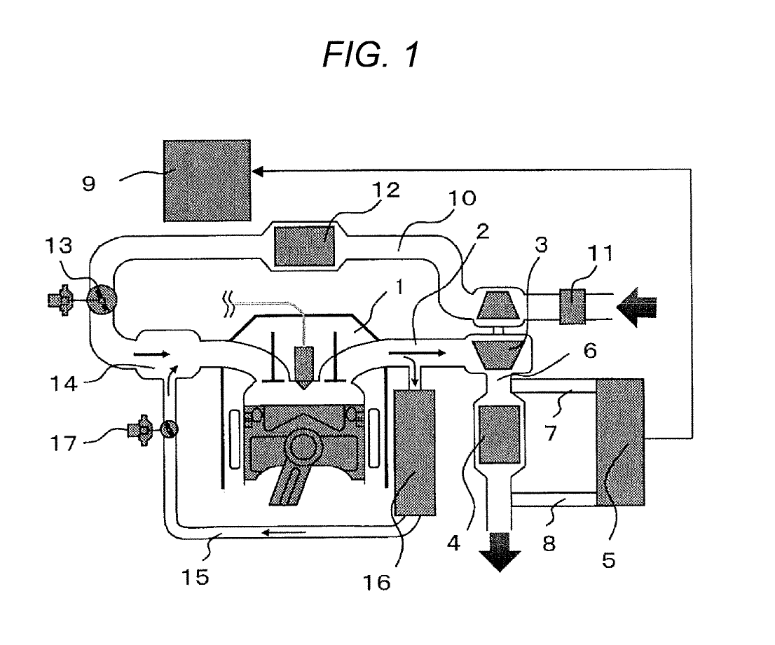

FIG. 1 illustrates the whole structure of a diesel engine that is an internal combustion engine provided with a pressure sensor apparatus according to the present invention.

An exhaust passage 2 connecting with an exhaust port of an internal combustion engine 1 is provided with a turbocharger 3 and a DPF 4. A pressure sensor apparatus 5 detects the pressure in an exhaust passage 6 through pressure introduction pipes 7 and 8 such as a hose. The pressure sensor apparatus 5 detects the upstream and downstream pressures of the DPF 4 to output, to an ECU 9, a signal corresponding to the upstream absolute pressure of the DPF 4, a signal corresponding to the downstream absolute pressure of the DPF 4, and a signal corresponding to the differential pressure between the upstream and downstream pressures of the DPF 4.

The ECU 9 determines based on the differential pressure detected by the pressure sensor apparatus 5 whether the DPF 4 is clogged. When it is determined that the DPF 4 is clogged, the temperature of the DPF 4 is increased to burn out the collected PM in order to resolve the clogging.

An airflow measurement device 11 is placed at an intake passage 10 to detect the amount of the intake airflow. The intake passage 10 is provided with an intercooler 12 and an intake throttle valve 13 and is communicated with an intake manifold 14.

Further, an exhaust recirculation passage 15 is communicated with the intake manifold 14 from the exhaust passage 2 and is provided with an EGR cooler 16 and an exhaust recirculation passage throttle valve 17.

The output signals from the pressure sensor apparatus 5 and the airflow measurement device 11 and the output signals from various sensors (not illustrated in the drawings) are input to the ECU 9 in order to notify the condition of each unit.

The present invention is a pressure sensor apparatus configured to detect, through the pressure introduction pipes 7 and 8 such as a hose, the upstream and downstream pressures of the DPF 4 installed in the exhaust system of a diesel engine and configured to collect particular matter. A pressure sensor apparatus detects the outputs of the upstream and downstream absolute pressures of the DPF 4 and the difference between the upstream and downstream pressures of the DPF 4 so that the clogging of the DPF 4 can be determined.

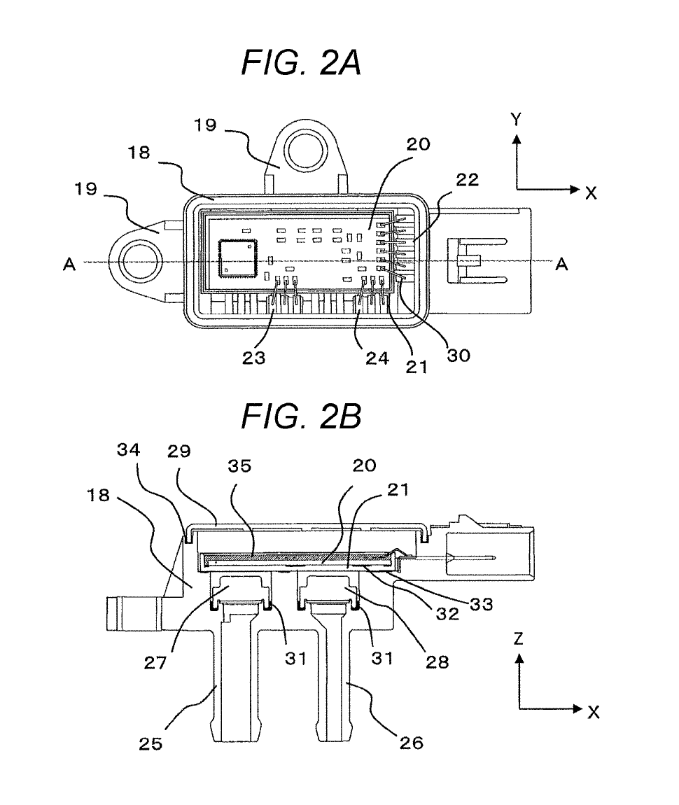

As illustrated in FIGS. 2A and 2B, a pressure sensor apparatus according to a first embodiment of the present invention includes a housing 18 having a connector terminal 22, an upstream pressure introduction passage 25, a downstream pressure introduction passage 26, and a mounting portion 19, intermediate terminals 23 and 24 inserted into the housing 18, pressure detection elements 27 and 28 provided in the housing 18, a base portion 21 provided on the pressure detection elements 27 and 28, a sensor circuit substrate 20 provided in the base portion 21, and a cover 29.

Each of the upstream pressure detection element 27 configured to detect the upstream pressure of the DPF 4 and the downstream pressure detection element 28 configured to detect the downstream pressure of the DPF 4 is attached to the housing 18 with epoxide-based adhesive A31.

The upstream pressure detection element 27 is electrically connected with an end of each of the intermediate terminals 23, for example, by welding. The downstream pressure detection element 28 is electrically connected with an end of each of the intermediate terminals 24, for example, by welding.

The sensor circuit substrate 20 is attached to the base portion 21 formed with a resin material with epoxide-based adhesive B32. The base portion 21 is attached to the housing 18 with epoxide-based adhesive B33.

A bonding wire 30 electrically connects the connector terminal 22 with the sensor circuit substrate 20, electrically connects the other end of each of the intermediate terminals 23 with the sensor circuit substrate 20 and electrically connects the other end of each of the intermediate terminals 24 with the sensor circuit substrate 20.

Protective silicone gel 35 is applied on the sensor circuit substrate 20 because various electronic components are installed in the sensor circuit substrate 20. The cover 29 is attached to the housing 18 with epoxide-based adhesive C34 in order to protect the sensor circuit substrate 20 and the bonding wire 30 from contamination, water and the like under an environment in which the apparatus is installed.

The intermediate terminals 23 and 24 are inserted into the housing 18 and the pressure detection elements 27 and 28 are connected with the sensor circuit substrate 20 through the intermediate terminals 23 and 24 so that the sensor circuit substrate 20 can be placed above the pressure detection elements 27 and 28. In other words, this can form a hierarchic structure. Arranging the pressure detection elements 27 and 28 in the longitudinal direction of the sensor circuit substrate 20 and providing the sensor circuit substrate 20 above the pressure detection elements 27 and 28 can efficiently use the space in a horizontal direction. This can implement a pressure sensor apparatus downsized in a horizontal direction.

The neighborhood of the DPF 4 is not a suitable place to place a pressure sensor apparatus because the DPF 4 has a high temperature to burn out the collected PM. Thus, the place for placing a pressure sensor apparatus is limited to some extent. According to the first embodiment, the shape of the apparatus can be downsized so that the place capable of placing the apparatus is increased. This improves the flexibility to attach the pressure sensor apparatus.

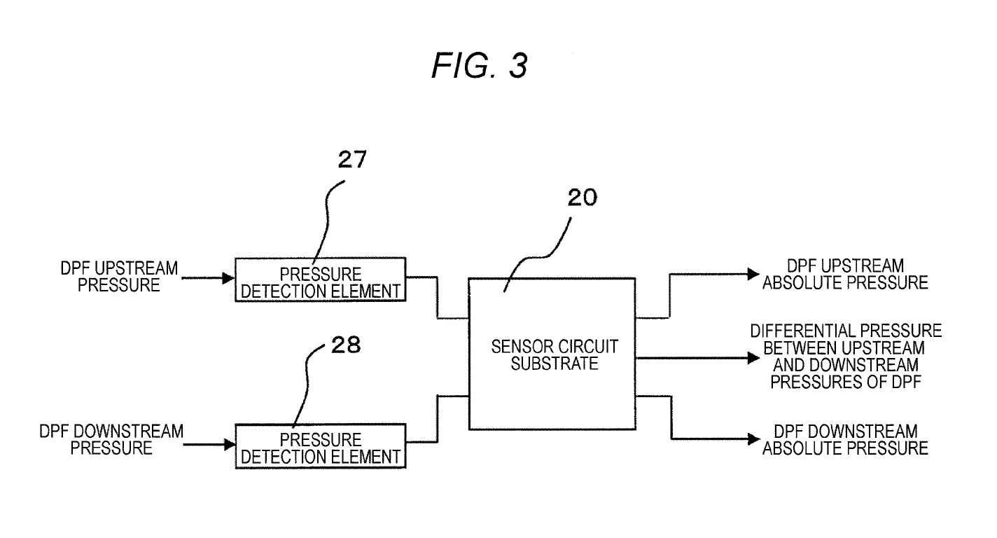

FIG. 3 illustrates a block diagram of the circuit of the present invention.

The pressure sensor apparatus 5 according to the first embodiment includes the upstream pressure detection element 27, the downstream pressure detection element 28, and the sensor circuit substrate 20 configured to calculate the differential pressure from the signals of the two detected pressures.

The pressure sensor apparatus 5 calculates and corrects the difference between the upstream and downstream pressures of the DPF in the sensor circuit substrate 20 based on the signal of the absolute pressure detected by the upstream pressure detection element 27 provided at the upper side of the upstream pressure introduction passage 25 and the signal of the absolute pressure detected by the downstream pressure detection element 28 provided at the upper side of the downstream pressure introduction passage 26 in order to output the signal of the differential pressure between the upstream and downstream pressures to outside, and also output the signals of the absolute pressures detected by the pressure detection elements 27 and 28 to outside through the sensor circuit substrate 20. The output of the pressure sensor apparatus is transmitted to the ECU.

Generally, when the engine operates, vibrations are generated in the outputs of the pressure detection elements 27 and 28 due to, for example, the exhaust pulsation including the exhaust gas passing through the pressure introduction pipes connected to the upstream pressure detection element 27 and the downstream pressure detection element 28, and through the DPF 4.

The fact that a pressure introduction pipe is clogged can be determined by detecting by the ECU whether the signal of the differential pressure vibrates. However, which of the pipes, the upstream pressure introduction pipe or the downstream pressure introduction pipe, is clogged cannot be determined only from the signal of the differential pressure. According to the pressure sensor apparatus of the present invention, in addition to the signal of the differential pressure between the upstream pressure and the downstream pressure, the signal of the upstream absolute pressure and the signal of the downstream absolute pressure that have been detected using the pressure detection elements 27 and 28 are transmitted to the ECU 9. When one of the upstream and downstream pressure introduction pipes is clogged, for example, with a foreign matter or by icing, the pressure is not transmitted from the clogged pressure introduction pipe to the pressure detection element. Thus, the signal of the absolute pressure does not vibrate and the output is fixed. The signal of the differential pressure between the upstream and downstream pressures is calculated based on the outputs of the two upstream and downstream pressure sensors. Thus, when one of the outputs of the pressure sensors is fixed, vibrations are also generated in the output of the differential pressure. In other words, when the output of the signal of the upstream absolute pressure is fixed and the signal of the differential pressure between the upstream and downstream pressures vibrates, it can be determined that the upstream pressure introduction pipe is clogged. When the signal of the absolute pressure is not fixed and the output of the signal of the differential pressure between the upstream and downstream pressures vibrates, it can be determined that the DPF 4 is clogged. Accordingly, using the signal of the absolute pressure, the pressure sensor apparatus of the present invention can determine which is clogged, the DPF 4 or the pressure introduction pipes and can further determine which is clogged, the upstream pressure introduction pipe or the downstream pressure introduction pipe. Even when a defect is generated in one of the DPF 4, the upstream pressure introduction pipe and the downstream pressure introduction pipe, where the defect is generated can be determined according to the signal of the absolute pressure and the signal of the differential pressure between the upstream and downstream pressures. This facilitates replacing only the component having the defect and can reduce the number of man-hours for the investigation, the component replacement, or the like. Note that, even if one of the upstream pressure detection element 27 and the downstream pressure detection element 28 is broken, the fact can be determined in the same manner.

To detect the clogging of the DPF 4, the upstream absolute pressure of the DPF 4 is measured using the upstream pressure detection element 27 and the downstream absolute pressure of the DPF 4 is measured using the downstream pressure detection element 28. Accordingly, if the downstream pressure introduction pipe 8 connected with the downstream side of the DPF 4 is mistakenly connected with the upstream pressure introduction passage 25, the upstream pressure detection element 27 detects the downstream pressure of the DPF 4. Thus, the clogging of the DPF 4 cannot correctly be determined. To prevent an improper insertion of the hose, the upstream pressure introduction passage 25 has a passage outer diameter different from the downstream pressure introduction passage 26 such that the upstream pressure introduction passage is easy to distinguish from the downstream pressure introduction passage.

The air on the upstream side of the DPF 4 includes foreign matters such as PM more than the air on the downstream side. Thus, the upstream pressure introduction passage 25 has a large diameter to prevent the pressure introduction passage from being clogged with a foreign matter. Especially, the passage inner diameter of the upstream pressure introduction passage 25 of 5.5 mm or more can prevent the water penetrating the upstream pressure introduction passage 25 from forming a water film. This can efficiently prevent the pressure introduction passage from being clogged.

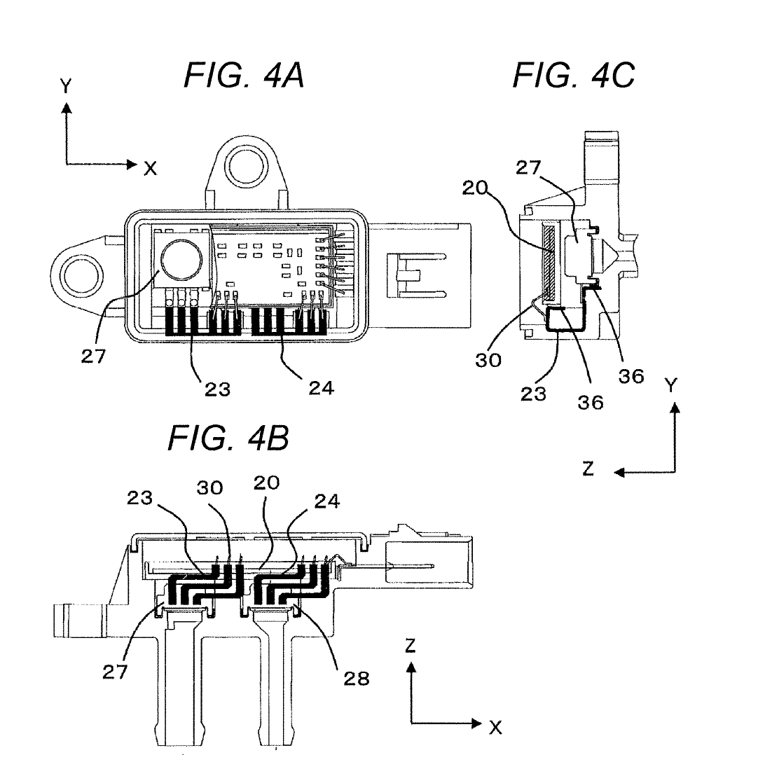

A second embodiment of the present invention will be described with reference to Figs. 4A to 4C. Note that the second embodiment has the same structure as the first embodiment except for the shapes of intermediate terminals 23 and 24, so that the description of the same structure will be omitted.

Each of the intermediate terminals 23 and 24 is formed into a cranked shape such that the positions of the pressure detection elements 27 and 28 are slid from the position connected with a sensor circuit substrate 20 placed above the pressure detection elements 27 and 28 in an X direction or, namely, in the longitudinal direction of the sensor circuit substrate 20.

When the pressure detection elements 27 and 28 and the sensor circuit substrate 20 are formed into a hierarchical structure, the connection between the pressure detection element 27 and the intermediate terminal 23 needs to be slid from the connection between the sensor circuit substrate 20 and the intermediate terminal 23 in a Y direction because the connections cannot be welded when the positions of the connections are overlapped with each other in the Y direction. According to the second embodiment of the present invention, the connection between the pressure detection element 27 and the intermediate terminal 23, the connection between the sensor circuit substrate 20 and the intermediate terminal 23, the connection between the pressure detection element 28 and the intermediate terminal 24, and the connection between the sensor circuit substrate 20 and the intermediate terminal 24 are placed in such a way as to be slid from each other in an X direction. This can connect the pressure detection elements 27 and 28 with the intermediate terminals 23 and 24 without sliding the connection with the sensor circuit substrate 20 from the connection with the pressure detection element in the Y direction. According to the second embodiment, the space in the X direction is efficiently used so that the size in the Y direction can be further smaller than the size of the first embodiment without increasing the size in the X direction. This can further downsize the apparatus.

An end and the other end of each of the intermediate terminals 23 and 24 are bent into an L-shape and the tips forming the L-shape are embedded and inserted into a housing so that a misalignment and displacement when the tips are inserted can be reduced. The structure can reduce the displacement of implementation so that the productivity and the reliability of the pressure sensor apparatus can be improved.

According to the first embodiment and the second embodiment of the present invention, the space in an engine room can efficiently be used by implementing a downsized pressure sensor apparatus.

Forming the intermediate terminal 23 into the same shape as the intermediate terminal 24 prevents the variety of the components of the present pressure sensor apparatus from being increased. This saves the cost.

A case in which the present pressure sensor apparatus measures the upstream and downstream pressures of the DPF has been described in detail. However, the present pressure sensor apparatus can be applied for detecting the pressure of an exhaust gas recirculation (hereinafter, referred to as an EGR). Detecting the difference between the upstream and downstream pressures of the EGR can observe the circulation. This can efficiently control the exhaust gas circulation. Even when the present pressure sensor apparatus is applied to the EGR, the space in the engine room can efficiently be used because a downsized pressure sensor apparatus is implemented. Further, using the present pressure sensor apparatus means that two absolute pressures can be detected with one unit. This works for cost saving.

What is claimed is:

1. A pressure sensor apparatus comprising:
a housing including a first pressure introduction passage for introducing a first pressure and a second pressure introduction passage for introducing a second pressure;
a first pressure detection element provided in the housing and configured to detect the pressure introduced from the first pressure introduction passage; and
a second pressure detection element provided in the housing and configured to detect the pressure introduced from the second pressure introduction passage, wherein
a circuit substrate is placed above the first and second pressure detection elements, and
a first intermediate terminal configured to electrically connect the first pressure detection element with the circuit substrate and a second intermediate terminal configured to electrically connect the second pressure detection element with the circuit substrate are inserted into the housing.

2. The pressure sensor apparatus according to claim 1, wherein
a connection between the first pressure detection element and the first intermediate terminal is slid from a connection between the circuit substrate and the first intermediate terminal in a longitudinal direction of the circuit substrate, and a connection between the second pressure detection element and the second intermediate terminal is slid from a connection between the circuit substrate and the second intermediate terminal in the longitudinal direction of the circuit substrate.

3. The pressure sensor apparatus according to claim 1, wherein
an end of the first intermediate terminal is slid from the other end in the longitudinal direction of the circuit substrate, and an end of the second intermediate terminal is slid from the other end in the longitudinal direction of the circuit substrate.

4. The pressure sensor apparatus according to claim 1, wherein
the end of each of the first and second intermediate terminals is formed into an L-shape.

5. The pressure sensor apparatus according to claim 4, wherein
the other end of each of the first and second intermediate terminals is formed into an L-shape.

6. The pressure sensor apparatus according to claim 5, wherein
a tip of the L-shaped ends of each of the first and second intermediate terminals is covered with resin.

7. The pressure sensor apparatus according to claim 1, wherein
the first pressure introduction passage has a pressure introduction passage diameter different from the second pressure introduction passage.

8. The pressure sensor apparatus according to claim 1, wherein
portions between the first and second pressure introduction passages and an inside of the housing are sealed with epoxide-based resin in order to prevent pressures introduced into the first and second pressure introduction passages from being transmitted to the inside of the housing.

9. The pressure sensor apparatus according to claim 1, wherein
a difference between an upstream pressure and an downstream pressure of a diesel particulate filter placed at an exhaust system of a diesel engine and configured to collect particulate matter is detected through a pressure introduction pipe and a hose.

10. The pressure sensor apparatus according to claim 1, wherein
absolute pressures on an intake side and an exhaust side of an exhaust gas recirculation and a difference between the pressures are detected through a pressure introduction pipe and a hose, and the exhaust gas recirculation returns a part of an exhaust gas to an intake air and takes the exhaust gas in a combustion chamber again to lower a concentration of oxygen in the intake air with an inert gas and lowers a combustion temperature with a cooler in order to inhibit a generation of NOx.
